(19) United States
(12) Patent Application Publication
(10) Pub. No.: US 2013/0265170 A1
(43) Pub. Date: Oct. 10, 2013

(54) INDICATING UNIT AND ELECTRONIC DEVICE USING SAME

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: LU-QING MENG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/705,361

(22) Filed: Dec. 5, 2012

(30) Foreign Application Priority Data
Apr. 6, 2012 (CN) 201220141741.8

(51) Int. Cl. G08B 5/36

(52) U.S. Cl. CPC G08B 5/36
USPC 340/815.45; 340/815.4

(57) ABSTRACT

An electronic device includes a housing and an indicating unit. The indicating unit is received in an inner surface of the housing. The illumination element includes an illumination element and a cover. A symbol for indicating the state of the electronic device is provided on a surface of the cover. The light emitted from the illumination element passes through or around the symbol, reproducing the shape of the symbol on a translucent/transparent portion of the housing.

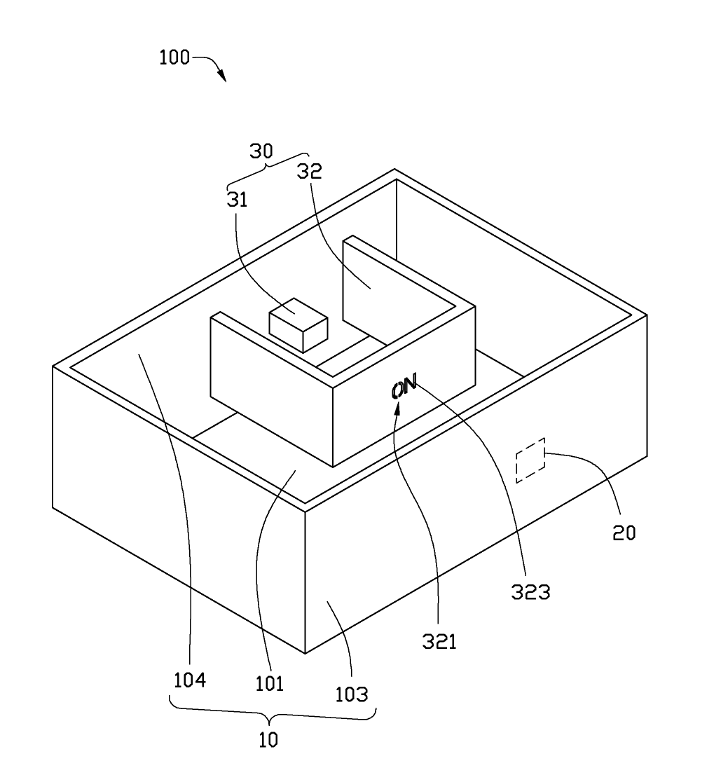

### BACKGROUND

1. Technical Field

The present disclosure relates to an electronic device having an indicating unit for indicating states of the electronic device.

2. Description of Related Art

Electronic devices, such as notebook computers and disc players, include a display unit, for displaying the current working state of the electronic devices, such as an off state and a working state. The display may be a fluorescent image display or a LED digital tube. However, the design of these display units are complex, and the cost of these display units is high.

Therefore, there is room for improvement in the art.

### BRIEF DESCRIPTION OF THE DRAWING

Many aspects of the embodiments can be better understood with reference to the drawing. The components in the drawing are not necessarily drawn to scale, the emphasis instead being placed upon clearly illustrating the principles of the embodiments.

The figure is a perspective view of an embodiment of an indicating unit in an electronic device.

### DETAILED DESCRIPTION

The figure shows a part of an electronic device 100 which may be in an off state and a working state. The electronic device 100 includes a housing 10, a display unit 20, an indicating unit 30 and a switch (not shown) mounted on the housing 10. The electronic device 100 further includes a controlling unit and a detecting unit (not shown) electronically connected to the controlling unit. The switch is used for turning on/off the electronic device 100. The indicating unit 30 is secured in the housing 10 for indicating states of the electronic device 100. The electronic device 100 may be a notebook computer, a disc player, or other electronic device. In the embodiment, the electronic device 100 is a disc player.

The housing 10 includes a base 101 and four sidewalls protruding from rims of the base 101 (hereinafter, a first sidewall 103, a second sidewall 104 opposite to the first sidewall 103, and two opposite sidewalls). The display unit 20 is secured on the first sidewall 103. In the embodiment, the display unit 20 is a portion of the first sidewall 103 and is translucent or transparent. In another embodiment, whole of the first sidewall 103 can be made of translucent or transparent material for acting as the display unit 20. The display unit 20 also can be a separate component secured to the first sidewall 103.

The indicating unit 30 is secured in the housing 10 and corresponds to the display unit 20. The indicating unit 30 includes an illumination element 31 and a cover 32. The illumination element 31 is secured to the second sidewall 104 and faces to the display unit 20. In the embodiment, the illumination element 31 includes at least one LED (light-emitting diode). The top of the illumination element 31 is substantially rectangular, and emits light to illuminate the center of the cover 32. In another embodiment, the shape of the illumination element 31 can be elliptical or other shape.

The cover 32 is substantially the shape of a U, and is secured to a surface of the second sidewall 104 facing to the first sidewall 103. The cover 32 houses the illumination element 31 and focuses light from the illumination element 31. The cover 32 defines a symbol 321 for indicating states of the electronic device 100. The symbol 321, the illumination element 31 and the display unit 20 are aligned with each other. The symbol 321 is illuminated by light emitted from the illumination element 31, and is visible when the display unit 20 is viewed. In the embodiment, the symbol 321 is a plurality of slots 323 defined on the cover 32. The slots 323 cooperate with each other to form the word “ON” for indicating that the electronic device 100 is in a working state. Thus, the light from the illumination element 31 directly passes through the slots 323 to reproduce an image of the word “ON” without other additional components. In another embodiment, the symbol 321 can be a groove defined on the cover 32. The portion of the groove is made of transparent material; and at least one portion of the display unit 20 above the symbol 321 is also made of transparent material. Thus, the light from the illumination element 31 passes through the groove to form the symbol 321 on the display unit 20, for indicating states of the electronic device 100.

In use, when the detecting unit detects the electronic device 100 is in working state, the detecting unit transmits a signal to the controlling unit. The controlling unit responds to the signal and turns on the indicating unit 30, the light from the illumination element 31 passes through the slots 323 to visibly reproduce the symbol 321, such as the word “ON”, on the display unit 20. The user will find it very convenient to know the working state of the electronic device.

Although information and the advantages of the present embodiments have been set forth in the foregoing description, together with details of the structures and functions of the present embodiments, the disclosure is illustrative only; changes may be made in detail, especially in the matters of shape, size, and arrangement of parts within the principles of the present embodiments to the full extent indicated by the broad general meaning of the terms in which the appended claims are expressed.

1. An electronic device, comprising:
a housing;
an indicating unit received in the housing, the indicating unit comprising:
an illumination element arranged on the housing; and
a cover covering the illumination element;
wherein a symbol for indicating the state of the electronic device is provided on a surface of the cover, the light emitted from the illumination element passes through the symbol and reproduces the shape of the symbol on the housing for indicating the state of the electronic device which is viewed by a user.

2. The electronic device as claimed in claim 1, further comprises a display unit secured to the housing and aligned with the cover for allowing the symbol to be visible.

3. The electronic device as claimed in claim 1, wherein a portion of the housing is formed to be a display unit for displaying the symbol.

4. The electronic device as claimed in claim 2, wherein at least a portion of the display unit corresponding to the symbol is made of transparent material.

5. The electronic device as claimed in claim 1, wherein the illumination element includes at least one light-emitting diode.

6. The electronic device as claimed in claim 5, wherein the top of the illumination element is rectangular-shaped, for focusing the light.

7. The electronic device as claimed in claim 1, wherein the symbol is a plurality of slots defined on the cover.

8. An indicating unit received in an electronic device with a housing, comprising:
an illumination element arranged on the housing; and
a cover covering the illumination element;
wherein a symbol for indicating the state of the electronic device is provided on a surface of the cover, the light emitted from the illumination element passes through the symbol and reproduces the shape of the symbol on the housing for indicating the state of the electronic device which is viewed by a user.

9. The indicating unit as claimed in claim 8, wherein a display unit aligned with the cover is secured to the housing for displaying the symbol.

10. The indicating unit as claimed in claim 8, wherein a portion of the housing is formed to be a display unit for displaying the symbol.

11. The indicating unit as claimed in claim 9, wherein at least one portion of the display unit corresponding to the symbol is transparent material.

12. The indicating unit as claimed in claim 8, wherein the illumination element includes at least one light-emitting diode.

13. The indicating unit as claimed in claim 12, wherein the top of the illumination element is rectangular-shaped, for focusing the light emitted from the illumination element.

14. The indicating unit as claimed in claim 4, wherein the symbol is a plurality of slots defined on the cover.

15. The electronic device as claimed in claim 3, wherein at least a portion of the display unit corresponding to the symbol is made of transparent material.

16. The indicating unit as claimed in claim 10, wherein at least one portion of the display unit corresponding to the symbol is transparent material.
